(19) United States
(12) Patent Application Publication
(10) Pub. No.: US 2020/0384521 A1
(43) Pub. Date: Dec. 10, 2020

(54) METHOD AND SYSTEM THAT PRODUCES BENT PARTS FROM INSULATED FLAT MATERIAL

(71) Applicant: WAFIOS Aktiengesellschaft, Reutlingen (DE)

(72) Inventor: Robin Sautter, Pfullingen (DE)

(21) Appl. No.: 16/478,599

(22) PCT Filed: Jan. 11, 2018
(86) PCT No.: PCT/EP2018/050675

§ 371 Date: Jul. 17, 2019

(30) Foreign Application Priority Data
Jan. 18, 2017 (DE) 10 2017 200 745.1

(51) Int. Cl. B21D 7/12; B21D 7/16

(52) U.S. Cl. CPC B21D 7/12; H01B 7/17; B21D 7/16

(57) ABSTRACT

A method of producing a bent part from insulated flat material having a flat electrically conducting carrier material sheathed by an electrically insulating insulation layer includes feeding the insulated flat material from a material supply to a bending machine; in the bending machine, forming a two-dimensionally or three-dimensionally bent part bent from insulated flat material; severing the bent part in a cutting operation from the fed insulated flat material; and removing part of the insulation layer in an insulation-stripping operation from the electrically conducting carrier material in at least one portion of the insulated flat material, wherein the insulation-stripping operation on the flat material guided in the bending machine by an insulation-stripping installation that is integrated in the bending machine is carried out by a continuous method on the flat material running through the insulation-stripping installation prior to severing the bent part from the fed flat material.

### TECHNICAL FIELD

This disclosure relates to a method of producing bent parts from insulated flat material, as well as to a system suitable for carrying out the method, having a bending machine that bends insulated flat material and an insulation-stripping installation that strips the insulation from portions of the insulated flat material.

### BACKGROUND

Vehicles having a fully or partially electrical drive are increasingly offered in the market. The vehicles in most instances possess high-performance energy storage systems having a plurality of battery modules. The electrical energy has to be transported between the individual battery modules. To this end, insulated and bent copper or aluminum rails also referred to as “current rails” are used. Furthermore, the cable harnesses that in the longitudinal direction of vehicles run between the front and the rear are increasingly replaced by current rails. By virtue of the ever increasing currents, current rails having a correspondingly large current-conducting cross section are required. Since the installation spaces available for the insulation of current rails are to some extent comparatively tight and geometrically complex, current rails having bends at one or a plurality of locations are often required.

In the production of insulated flat material for a current rail, an electrically conducting carrier material (for example, a flat wire from aluminum or copper) is first jacketed or sheathed, respectively, continuously by way of an electrically insulating insulation layer. However, the insulation layer should be removed at the contact locations that connect the current rail so that the carrier material is in an ideally bare state. To this end, an operative step of “insulation stripping” is carried out. Insulation stripping is a procedure in which part of the insulating sheath (also referred to as “insulation” or “isolation” or “insulation layer”) of an electrical conductor is removed from a specific length required for the connection. Current rails are then typically either fixedly screwed, fixedly jammed, or fixedly soldered for subsequent fastening in the respective installation environment.

The operative step of insulation stripping is nowadays carried out after the bending process with the aid of separate stand-alone insulation-stripping machines.

It could nonetheless be helpful to provide a method and a system of the type mentioned at the outset that permits the manufacturing of partially stripped of the insulation current rails of high quality with high productivity, wherein the stripped of the insulation portions of the carrier material provided for contacting herein have an ideally undamaged clean surface.

### SUMMARY

I provide a method of producing a bent part from insulated flat material having a flat electrically conducting carrier material sheathed by an electrically insulating insulation layer, including feeding the insulated flat material from a material supply to a bending machine; in the bending machine, forming a two-dimensionally or three-dimensionally bent part bent from insulated flat material; severing the bent part in a cutting operation from the fed insulated flat material; and removing part of the insulation layer in an insulation-stripping operation from the electrically conducting carrier material in at least one portion of the insulated flat material, wherein the insulation-stripping operation on the flat material guided in the bending machine by an insulation-stripping installation that is integrated in the bending machine is carried out by a continuous method on the flat material running through the insulation-stripping installation prior to severing the bent part from the fed flat material.

I also provide a system that produces bent parts from insulated flat material, having a bending machine that bends insulated flat material and an insulation-stripping installation that strips the insulation from portions of the insulated flat material, wherein the bending machine has a drawing-in installation that draws-in insulated flat material from a material supply, a bending installation having a bending head that bends the insulated flat material to a two-dimensional or three-dimensional bent part bent from insulated material and a cutting installation that severs the bent part from the fed insulated flat material, and the bending machine has an integrated insulation-stripping installation that strips the insulation of portions of the insulated flat material by a continuous method on the flat material running through the insulation-stripping installation prior to the severing of the bent part from the fed flat material.

### BRIEF DESCRIPTION OF THE DRAWINGS

FIG. 1 shows an example of a bending machine for insulated flat material, having an integrated insulation-stripping installation.

FIG. 2 shows an isometric front view of an example of an insulation-stripping installation.

FIG. 3 shows an isometric illustration of two knife shafts of the insulation-stripping installation of FIG. 2, the two knife shafts being rotatable in a counter-rotating manner.

FIGS. 4 to 7 show different phases of an insulation-stripping operation with the aid of the insulation-stripping installation.

FIG. 8 shows an example having an insulation-stripping installation that permits stripping of the insulation from all four lateral faces of a flat material having a rectangular cross section by the continuous method.

FIG. 9 shows an example of an insulation-stripping installation having two knife shafts capable of being driven in a mutually separate manner.

### DETAILED DESCRIPTION

In the method, the flat material that is not yet stripped of the insulation is fed from a material supply (for example, a reel having a coil) to the bending machine. To this end, the bending machine has a drawing-in installation that feeds insulated flat material from the material supply. The insulated flat material in the bending machine is formed to a two-dimensionally or three-dimensionally bent part bent from insulated flat material. To this end, the bending machine has inter alia a bending installation disposed downstream of the drawing-in installation and has a bending head that bends the insulated flat material. The flat material is fed to the bending installation with the aid of the drawing-in installation. After completion of the bending operation in which one or a plurality of bends are generated in one or a plurality of bending planes on the insulated flat material, the bent part in a cutting operation is severed from the fed insulated flat material. To this end, a cutting installation severs the bent part from the fed insulated flat material is provided on the bending machine.

The insulation-stripping operation is carried out on the flat material guided in the bending machine prior to severing the bent part from the fed flat material. To carry out this insulation-stripping operation, the bending machine has an integrated insulation-stripping installation that strips the insulation from one or a plurality of portions of the insulated flat material prior to severing the bent part from the fed flat material. Since the insulation-stripping operation is carried out prior to severing the bent part from the fed flat material, no transportation of a finished bent part that is not yet stripped of the insulation to an insulation-stripping installation separate from the bending machine is required. Since the flat material for the insulation-stripping operation is guided and/or held in the bending machine, no dedicated mountings or manipulators to handle the flat material in the context of the insulation-stripping operation are required.

The insulation-stripping operation is carried out by the continuous method. This means that the insulation-stripping operation is carried out on a flat material running through the insulation-stripping installation. A movement of the flat material, for example, an infeed motion, is thus provided for the actual insulation-stripping procedure, that is to say the insulation-stripping operation. The insulation-stripping takes place during a movement of the flat material, the movement contributing toward the insulation-stripping.

The infeed movement of the flat material in the running direction in the continuous method is preferably precisely predefined by a corresponding actuation of the drawing-in installation and/or operative movements of the bending installation of the bending machine. Installations available on the bending machine that generate the onward movement of the flat material can thus be used in the insulation-stripping operation. Infeed movements and retraction movements of the flat material can be utilized in combination. The insulation-stripping operation herein can be carried out without the operative movements required for the bending process having to be stopped for the insulation-stripping operation. The bending machine can productively operate without, or almost without, any additional auxiliary process times for the insulation-stripping.

In the insulation-stripping by the continuous method, a portion of arbitrary length of the flat material can be stripped of the insulation by way of a insulation-stripping installation disposed to be static when required. A static disposal means that the insulation-stripping installation as an entity does not have to be moved to carry out the insulation-stripping operation and, thus, can remain in the position thereof to be stationary.

The insulation-stripping operation with the aid of the insulation-stripping installation is preferably carried out under the control of a control installation of the bending machine. This control can be implemented directly or indirectly. In direct control, the control installation of the bending machine directly controls the insulation-stripping installation. In indirect control, the insulation-stripping installation can have a dedicated sub-control installation actuated by the control installation of the bending machine or a superordinate control station, or is synchronized with the control installation of the bending machine or the superordinate control station, respectively. An insulation-stripping operation integrated in the process and which in a bending machine can run automatically to be independent of interventions by an operator is thus possible in these examples. The method can then be carried out completely with the aid of a bending machine and can run fully automatically in all steps. The flat material can be stripped of the insulation at arbitrary locations. The point of insulation-stripping, or the position and length of a portion of the flat material to be stripped of the insulation, respectively, can be precisely predefined (directly or indirectly) by way of the control of the bending machine.

A particularly reliable example is distinguished in that the insulation-stripping installation is disposed between the drawing-in installation and a bending head of the bending installation. On account thereof, it can inter alia be achieved that the flat material to be stripped of the insulation during the insulation-stripping operation on both sides of a portion to be stripped of the insulation is guided through and/or held by controllable installations of the bending machine (in particular the drawing-in installation and the bending installation). On account thereof, the insulation-stripping operation can be carried out with particularly high precision and to be gentle to the carrier material to be exposed. Moreover, it can be achieved on account of the disposal between the drawing-in installation and the bending head, or bending installation, respectively, that the overall installation size of the bending machine is not, or not significantly, enlarged on account of the integration of the insulation-stripping installation.

In some examples, the drawing-in installation is rotatable about a drawing-in axis. On account thereof, it is inter alia possible for the flat material that changes between different bending planes to be rotated by rotating the drawing-insulation. In some examples, the insulation-stripping installation is fastened to the drawing-in installation and, conjointly with the drawing-in installation, is rotatable about the drawing-in direction. Particularly compact and flexible utilizable examples are implementable here. It is also possible for the insulation-stripping installation not to be fastened to the drawing-in installation and optionally rotated in a manner synchronous with the drawing-in installation by a dedicated drive.

There are thus examples in which the insulation-stripping installation is not fastened to the drawing-in installation, but assembled separately from the latter at the installation location of the insulation-stripping installation in the bending machine. If a rotation that is synchronous with the drawing-in installation is desired, it can be provided that the insulation-stripping installation is rotated in a manner synchronous with the drawing-installation by a dedicated drive. Non-rotatable examples are also possible.

There are different possibilities to technically implement the process of insulation-stripping, thus the insulation-stripping operation. As methods utilizable in principle, subtractive methods having a geometrically determined blade, for example, are to be considered such as scraping or milling, for example, in particular circumferential milling, or thermal separation, or the removal of the insulation material by a laser. Removal of the insulation layer by brushes or grinding are further options.

We discovered that an insulation-stripping operation similar to the process of peeling can be advantageous in many or all cases. Preferably, the insulation-stripping installation has at least one knife having a straight cutting edge, wherein the knife is movable between a neutral position without an engagement of the knife on the insulated flat material and an operating position in which the cutting edge of the knife is disposed close to a (substantially planar) lateral face of the carrier material to be exposed such that a part of the insulation layer acquired by the knife is removed from the carrier material in the continuing movement of the flat material relative to the knife. The insulation-stripping installation of this example can accordingly also be referred to as a peeling installation.

In this example, the knife moved to the operating position can remain still, or be immovable, respectively, while the relative movement between the knife and the flat material required for peeling is caused exclusively by movement of the flat material in the running direction thereof (longitudinal direction). In this method, the knife can be designed and disposed such that the severed insulation material in the insulation-stripping is created in the form of a large contiguous “shaving” that, during the peeling process, typically curls up to a greater or lesser extent. On account thereof, the severed insulation material can be released and removed in a contiguous manner in large pieces.

It typically suffices for a collection container or a catch container, respectively, that collects the shavings to be attached in the region below the insulation-stripping installation.

Suctioning of insulation material is typically not required and also preferably not provided. The process is extremely effective in terms of gently exposing the carrier material in the portion to be stripped of the insulation and is very environmentally friendly. Insulation-stripping installations having relatively compact construction dimensions that can be integrated in a bending machine in a relatively simple manner can be implemented.

In an insulation-stripping installation having a knife of the type described, movement between the retracted neutral position and the operating position engaging with the flat material can be implemented by a translatory movement. Preferably, the insulation-stripping installation has at least one knife shaft rotatable about a rotation axis and supports the knife, wherein the knife by rotation of the knife shaft about the rotation axis is movable from the neutral position to the operating position and, preferably in an opposing direction, from the operating position to the neutral position. A rapid change between the neutral position and the operating position is possible by way of a rotation, wherein the position of the cutting edge in relation to the flat material can contemporaneously be predefined in a reproducible manner with high precision. On account thereof, it can inter alia be prevented in a simple manner that the knife is set to approach too far in the direction toward the carrier material on account of which the surface of the electrically conducting carrier material could be damaged by the removal of material, or is set to approach to be too short, as a result of which removal of the insulation possibly only occurs in the interior of the insulation material such that remnants of insulation material can adhere to the surface of the carrier material to be exposed.

The insulation materials, mostly polymer-based, that are usually used in current rails and similar workpieces are typically relatively tough so that the released shavings or portions, respectively, can remain on the flat material that has been stripped of the insulation when no special measures are provided. In some examples, additionally to the knife (by way of which the insulation-stripping operation, for example, the peeling operation is carried out), a further knife is attached, the further knife by rotation of the knife shaft being movable to operatively engage with the flat material in the manner that a portion of the insulation material peeled off by the (first mentioned) knife is capable of being severed from the insulation material remaining on the carrier material by the further knife. In this example, two knives having dissimilar functions and that by suitable rotation of the knife shaft can alternately be brought to engage with the workpiece (flat material) to be machined are thus attached to the rotatable tool carrier (knife shaft).

In examples in which the knife for the peeling operation is attached to a rotatable knife shaft it has proven particularly advantageous for the knife to have a cutting wedge having a cutting face and a tool flank, wherein the knife is designed and disposed such that the tool flank of the cutting edge in the operating position runs to be substantially parallel to the lateral face of the carrier material to be exposed. In other words, a release angle close to 0° or at 0° is chosen. On account thereof it can be achieved that the “orbit” of the cutting edge, thus the circle or arc travelled by the cutting edge in the rotation of the knife shaft, is tangential to the lateral face of the carrier material to be exposed. On account thereof, dents or other damage on the surface to be exposed can be created neither when pivoting the knife into the operating position nor when pivoting the knife out of the operating position.

Insulation stripping that is particularly gentle and without damage to the carrier material to be exposed in some examples is furthermore facilitated in that the knife shaft in relation to the flat material running through is disposed such that a plane defined by the cutting edge of the knife and the rotation axis of the knife shaft is substantially perpendicular on the lateral face of the carrier material to be exposed when the knife is situated in the operating position.

The concept of insulation-stripping of insulated flat material can be implemented in different examples. There can be applications in which insulation-stripping of the flat material is desired only on one side, for example, on one of the wider lateral faces (broadsides). One-sided insulation-stripping can be sufficient in this instance. In preferred examples, it is provided that the flat material is contemporaneously stripped of the insulation on two mutually opposite sides of the flat material. To this end, the insulation-stripping installation can have a first knife shaft and a second knife shaft rotatable about mutually parallel rotation axes, wherein a passage opening for the flat material to be stripped of the insulation lies between the knife shafts. The two knife shafts can be constructed to be mutually symmetrical. The spacing between the rotation axes can be adjustable in a stepless manner.

In some examples, the two knife shafts are mechanically forcibly coupled by way of a gearbox in the manner that the two knife shafts with the aid of a single drive can be rotated in counter-rotating manner between the operating position and the neutral position. Other examples have a dedicated drive for each of the knife shafts. The drives by way of the control of the bending machine can be actuated in a synchronous manner.

Further advantages are derived from the description hereunder of preferred examples explained hereunder by the figures.

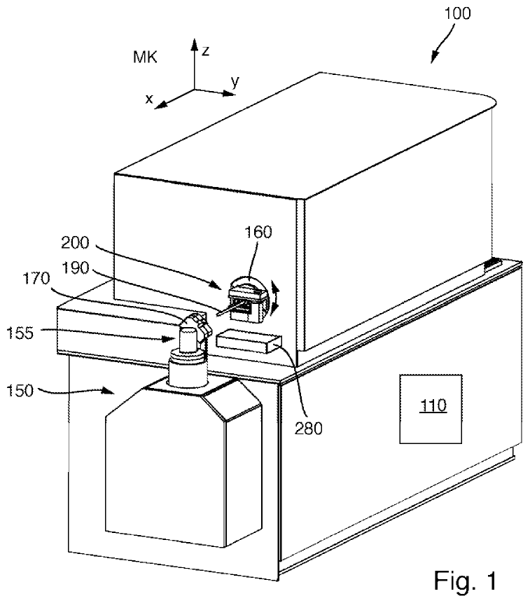

An example of a bending machine 100 that produces two-dimensional or three-dimensional bent parts bent from insulated flat material is shown in FIG. 1. The bending machine has an integrated insulation-stripping installation that strips the insulation from portions of the insulated flat material before the completely-bent bent part is severed from the fed flat material. The bending machine has an orthogonal machine coordinate system MK identified by lower-case letters x, y, and z, and has a vertical z-axis and horizontal x- and y-axes. The x-axis in the example illustrated runs parallel to a drawing-in direction in which the flat material to be bent with the aid of a drawing-in installation 160 is fed to a downstream bending installation 150. The machine axes are driven in a controlled manner, yet to be mentioned later, and referred to by way of upper-case letters (for example, A-axis) are to be differentiated from the coordinate axes of the machine coordinate system. A control installation 110 of the bending machine controls and coordinates the operative movements of all machine axes.

The initial material to be formed, specifically insulated flat material 190, is drawn through the bending machine with the aid of a drawing-in installation. The drawing-in installation feeds insulated flat material from a material supply. The infeed force in the drawing-in direction (x-direction) herein is created by friction between drawing-in rollers of the drawing-in installation and the flat material. Depending on the construction mode, the drawing-in installation possesses a higher or lower number of roller pairs, for example, three or four roller pairs, wherein one roller pair comprises one pair of drawing-in rollers capable of being driven in a counter-rotating manner. For the flat material to be drawn-in in a gentle manner, the drawing-in rollers are designed as simple flat cylinders, thus having a substantially circular-cylindrical circumferential face. For the drawing-in rollers to be facilitated, the initial material, for example, a coil, is situated on a motor-operated reel. Once the machine commences with the drawing-in of the flat material, a sensor that actuates the motor of the reel is triggered.

Before the initial material (insulated flat material) enters the drawing-installation, the flat material passes a straightening unit which in the example has a number of rollers disposed in an offset manner.

For many bent parts, bends in different bending planes at different mutual angles are required such that the resulting bent parts are three-dimensionally bent. For this to be enabled without a complicated construction of the bending installation, it is provided in the bending machine of the example that the drawing-in installation 160 is rotatable about the drawing-in axis in both rotating directions. On account thereof, a change between bending planes can be carried out in a simple manner between individual bending operations. The components of the bending installation 150 per se can remain in the position of the components when the bending plane is changed. In this example, the drawing-in installation 160 and the upstream straightening installation are rotated with the aid of a servomotor of a corresponding machine axis (A-axis).

A numerically controlled bending installation 150 is provided to generate bends on the flat material 190 by forming. The flat material in the bending region is bent to the desired shape with the aid of a CNC bending head 155 of the bending installation. A CNC-controlled supporting table can optionally be provided to support comparatively long material portions when bending. The bending head of the example possesses two shafts rotatable in a mutually independent manner, specifically a mandrel shaft and a hollow shaft. Bending mandrels are situated on the mandrel shaft. The bending head can be equipped with different tools, depending on the machining desired. Large bent parts can be supported by a retrofittable supporting table.

A cutting installation 170 provided to sever the finished bent part (upon completion of all bending operations) from the fed insulated flat material is assembled between the bending region having the bending head of the bending installation 150 and the drawing-in installation 160. The cutting installation 170 is specified such that the flat material is separated by a shearing movement. By reversing the material draw-in it is possible for the bend last manufactured to be drawn in the direction of the cutting installation 170 such that the bent part can be separated very closely behind a bend. In some examples, it is possible for the cutting installation to be repositioned with the aid of a dedicated drive. Depending on the example of the cutting operation, the completely-bent bent part can either drop into a box provided therefor, or be received by an automation and conveyed onward to the next operative step.

In examples having a rotatable draw-in, the cutting installation can likewise be rotatable such that the cutting installation can rotate in a synchronous manner conjointly with the flat material to obtain optimal separating cuts (by way of cutting forces which are substantially perpendicular to the broadsides of the flat material).

The end side of the drawing-insulation 160 facing the bending installation 150 can be readily seen in FIG. 1. An insulation-stripping installation 200, integrated in the bending machine, that strips the insulation from portions of the insulated flat material prior to severing the bent part from the fed flat material is fastened to the end side of the drawing-in installation and therefore can conjointly rotate with the latter about the drawing-in direction.

Two-dimensionally or three-dimensionally bent current rails can inter alia be manufactured by the bending machine 100, such current rails being required inter alia in the automotive industry to transport electrical energy between the vehicle functional groups or within battery groups. The initial material is an insulated flat material substantially composed of an electrically conducting carrier material, an adhesion promoter on the surface of the carrier material, and an electrically insulating insulation layer on the adhesion promoter. The carrier material typically has a flat rectangular cross section having broadsides and narrow sides that run perpendicularly to the latter. The insulation layer completely sheathes the carrier material. The carrier material in most instances is composed of copper (Cu) or aluminum (Al), or also from alloys based on Cu and Al, respectively, and is responsible for conducting the current.

The width of the flat material (measured in the width direction perpendicular to the longitudinal direction) can be a multiple of the thickness (measured on the narrow sides), for example, be three times to seven times the thickness. Widths can be in the magnitude of a few millimeters up to a few centimeters, for example. The insulation layer usually has a thickness of less than 1 mm.

The insulation layer is often made from specific polyamide plastics materials. One advantage of polyamide layers is the saving in weight. The plastics material is part of the family of thermoplastics and in this example is required to avoid short circuits and electric shocks. Polyamide is very resistant to wear and is very tough and very strong. The material is resistant to many solvents, oils, and fuels, and is typically well suited to the temperature in use between −40° C. and 120° C. The insulation layer can be applied to the carrier material by extruding, for example, with the aid of an adhesion promoter. The adhesion promoter is advantageous because the polyamide layer can otherwise have corrugations by virtue of stretching or compressing, respectively, at the bending locations.

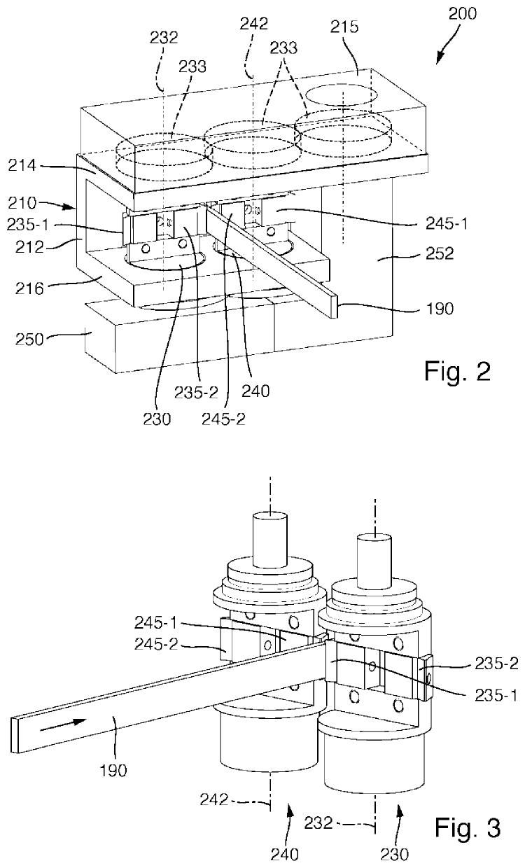

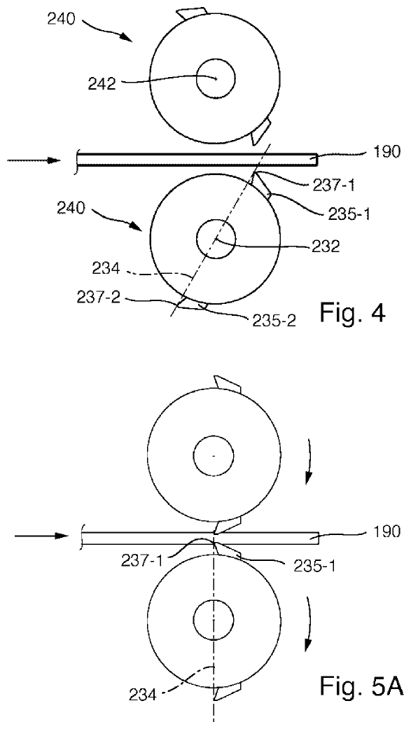

Details of the construction and operating mode of the insulation-stripping installation 200 from FIG. 1 will now be explained in more detail by FIGS. 2 to 7. FIG. 2 shows an isometric front view of the insulation-stripping installation 200, FIG. 3 shows an isometric illustration of two knife shafts of the insulation-stripping installation, the knife shafts being rotatable in a counter-rotating manner, and FIGS. 4 to 7 show different phases of an insulation-stripping operation with the aid of the insulation-stripping installation.

The insulation-stripping installation 200 has an approximately U-shaped housing 210 substantially composed of plate-shaped portions that are mutually orthogonal and supports all functional components of the insulation-stripping installation. A plate-shaped assembly portion 212 fastens the insulation-stripping installation to the end side of the rotatable drawing-in installation. There, the retrofittable insulation-stripping installation 200 can be screw-fitted with the aid of fastening screws and be readily removed when required. An upper support portion 214 orthogonal to the assembly portion, on the upper side of the assembly portion, supports a cover 215 that covers gearbox parts (for example, spur gears), yet to be explained. There is a lower support portion 216 parallel to the upper support portion 214 and by way of a spacing is disposed to be parallel to the upper support portion.

The insulation-stripping installation 200 has two knife shafts 230, 240 rotatable in an axially parallel and counter-rotating manner and each have two knives. The knives in the front view of FIG. 2 are shown in a rotational position assumed by the knife shafts when severing a shaving from insulation material at the end of an insulation-stripping operation (cf. FIG. 7). The knife shafts in FIG. 3 are shown in the operating position thereof during the insulation-stripping operation. The flat material 190 herein, arriving from the drawing-in installation, is moved onward along the direction of the arrow (infeed direction, or drawing-in direction, respectively). In FIG. 3, the observer thus looks onto the rear side of the insulation-stripping installation that faces the drawing-in installation.

A first knife shaft 230 by way of upper and lower journals is mounted in the upper and the lower support portions of the housing 210 such that the first knife shaft 230 is rotatable about the rotation axis 232. The first knife shaft 230 on mutually opposite sides supports a first knife 235-1 and a second knife 235-2. The second knife shaft 240 is rotatable in an axially parallel manner in relation to the first knife shaft about a rotation axis 242 and on mutually opposite sides supports a first knife 245-1 and a second knife 245-2. The knife shafts by end-side journals are mounted to be rotatable in the upper support portion or the lower support portion, respectively. The upper journals that protrude inwardly in the region of the housing cover 215 are forcibly coupled by way of gears 233 of a gearbox such that the knife shafts can only move in a mutually synchronous counter-rotating manner. The rotating movement of the knife shafts is effected by way of a single drive by a servomotor 250 that, to transmit rotating movements by way of a gearbox 252 and further transmission elements, is coupled to the gears fastened to the knife shafts. The motor and the gearbox 252 disposed at an angle to the motor are fastened to the upper support plate 214 of the housing. The motor per se is disposed below the knife shafts. An overall extremely compact construction mode results. The servomotor is controlled by way of the control installation 110.

FIG. 4 shows a view from above of the two knife shafts 230, 240. The flat material 190 by the drawing-in installation is fed from the left (in the direction of the arrow). In the situation in FIG. 4, the insulation-stripping installation is switched to a passing configuration in which the flat material can run through in the direction of the bending head without any contact with knives of the insulation-stripping installation. None of the knives engages with the flat material.

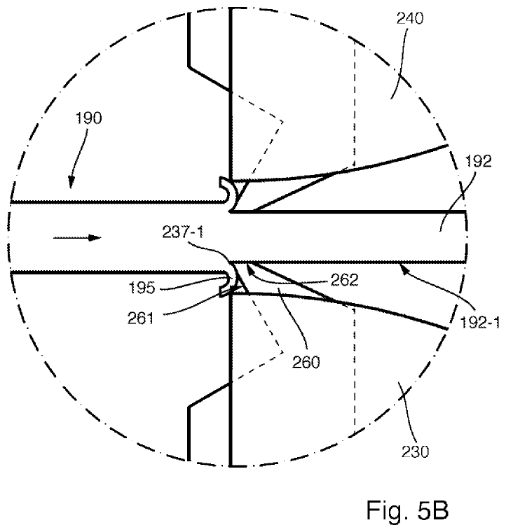

When a portion to be stripped of the insulation in the infeeding of the insulated flat material makes its way into the region of the insulation-stripping installation 200, the control installation of the bending machine emits a corresponding signal to the drive of the insulation-stripping installation. In response to the signal, the knife shafts by the motor 250 are rotated from the neutral position shown in FIG. 4 to the operating position shown in FIG. 5A. FIG. 5B shows this situation in more detail (first knife in the operating position).

The geometry of the arrangement will be explained in detail by the first knife shaft 230. The first knife 235-1 and the second knife 235-2 are of identical design. However, the knives have different functions. Each of the knives has a cutting wedge on which a straight cutting-edge 237-1 or 237-2, respectively, is configured. In a correct adjustment of the knives, the cutting edges run to be parallel to the rotation axis of the knife shaft. Both knives are situated on the same side of a radial plane 234 that runs through the rotation axis 232 of the knife shaft as well as through the cutting edges 237-1 and 237-2, respectively, of the opposite knives.

The region of the knife that participates in generation of shavings is understood to be the cutting wedge here (see FIG. 5B). The cutting wedge 260 is delimited by a cutting face 261 and a tool flank 262. The cutting face can come into direct contact with the shaved shaving (composed of insulation material). The cutting face is thus the face onto which the shaving runs on the cutting wedge. The face on the cutting wedge that lies opposite the exposed face created on the workpiece (flat material) is the tool flank 262. The line where there is mutual contact between the cutting face and the tool flank is the cutting edge 237-1. The angle between an imagined line perpendicular to the machining face of the workpiece to be machined and the cutting face on the cutting edge is referred to as the rake angle. The wedge angle is the angle between the cutting face and the tool flank. The relief angle is the angle between the face of the workpiece to be exposed and the tool flank.

The arrangement is chosen such that the two cutting edges of the mutually opposite knives lie on a common circle and the tool flanks can each be considered a fragment of a tangential plane on the circle. The tool flanks herein lie to be perpendicular on the radial plane 234 that includes the rotation axis. The relief angles of both knives are each 0°. This has an extremely positive effect on the insulation-stripping process and on the quality of the surface of the carrier material to be exposed, as will be explained in more detail by FIG. 5.

The cutting edge 237-1 of the first knife in the operating position shown in FIGS. 5A and 5B lies close to the lateral faces 192-1 of the carrier material 192 such that a part of the insulation layer acquired by the knife is removed or peeled, respectively, as a shaving 195 from the carrier material in the continuing movement of the flat material relative to the knife. The cutting edge 237-1 is longer than the width of the lateral face to be exposed and protrudes the latter somewhat at both ends. The complete lateral face 192-1 can thus be stripped of the insulation on the entire width in a single pass.

FIG. 5A shows the situation shortly after the knife shafts have pivoted or rotated, respectively, inward to the operating position. It can be seen in the enlarged detail (FIG. 5B) that the cutting edge of the first knife lies on the plane of the wide lateral face 192-1 of the flat material. The tool flank 262 runs to be parallel to the lateral face to be exposed and slides on the latter. The shaving 195 of the insulation material raised from the carrier material curls on the cutting face.

On account of the flat material being conveyed through the bending machine, or the insulation-stripping installation 200, respectively, the tool flanks of the mutually opposite first knives slide on the carrier material and insulation-stripping can be continuously performed without the flat material prior thereto being severed from the fed flat material.

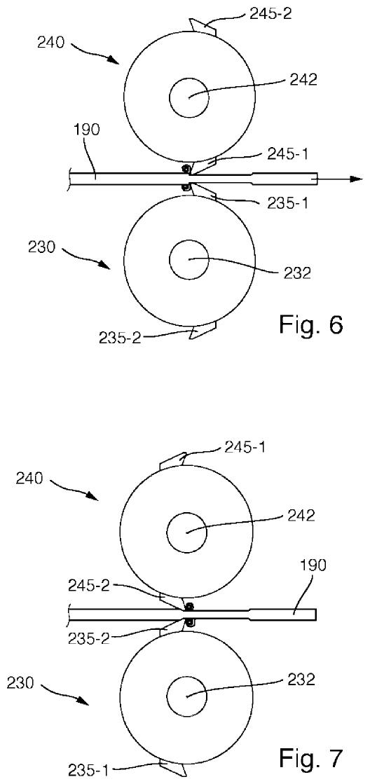

FIG. 6 shows a temporally following situation in which, after infeeding the flat material through the stationary knives, a somewhat longer shaving 195 of the insulation material has already been released from the carrier material. The shaving more or less intensely curls up in the region of the cutting face. By virtue of the toughness of the plastically deformable insulation material, the shaving is preserved in one piece.

For the created shaving from insulation material to be completely released from the workpiece (flat material) that is partially stripped of the insulation, the two knife shafts by the motor 250 are rotated in a synchronous manner by 180° in opposite directions. As can be readily seen in FIG. 7, the two knives 235-2, 245-1 on account thereof come to contemporaneously operatively engage with the workpiece and reliably sever the shavings that have curled up on both sides from the flat material that has been stripped of the insulation. The two knives have the same plunging radius as the first knives such that the shaving can be completely severed without the exposed carrier material being damaged. The dropping shavings can drop into a collection container 280 and do not have to be suctioned.

Depending on the machining, the flat material can be bent in a two-dimensional or three-dimensional manner. To this end, the flat material by the rotatable drawing-in installation 160 can be rotated about the longitudinal axis of the flat material. Since the insulation-stripping installation 200 is fixedly assembled on the drawing-in installation, the insulation-stripping installation conjointly rotates with the flat material such that the insulation-stripping installation does not have to be repositioned for machining, even in a rotation of the flat material.

It has yet to be mentioned that the insulation-stripping installation 200 is provided for double-sided machining in which the flat material is contemporaneously stripped of the insulation on two opposite sides of the flat material (here the broadsides). Parallel machining on opposite lateral faces also eliminates forces such that no dedicated counter bearings have to be provided. It is also possible for an insulation-stripping unit to be configured such that insulation-stripping is performed only on one side. To this end, one of the knife shafts can be replaced by a corresponding counter holder, for example, in the form of a roller or the like to suppress any yielding of the flat material in the engagement of the first knife of the knife shaft and guide the flat material when being stripped of the insulation.

It is explained by the figures in which manner two opposite lateral faces, for example, the broadsides of the flat material can be contemporaneously stripped of the insulation over an arbitrary length on an arbitrary portion. Of course, mutually opposite narrow sides can also be stripped of the insulation in an analogous manner. It is also possible for two knives to be placed vertically for the narrow sides of the flat material and the insulation material to thus be removed from the running flat material by scraping.

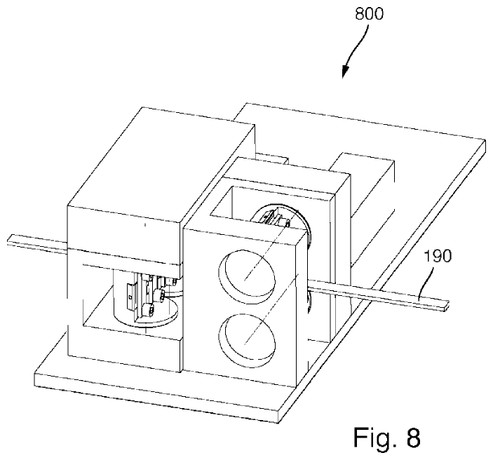

Additionally to a first insulation-stripping installation (to strip the insulation from opposite broadsides), it is also possible for an additional insulation-stripping installation to be attached to be offset by 90° to strip the insulation from broadsides as well as narrow sides of the flat material by the continuous method. On account thereof, yet another insulation-stripping installation is created. FIG. 8 shows an example of an insulation-stripping installation 800 having two pairs of knife shafts disposed behind one another and have different operative spacings between the knife blades.

The bending machine having an integrated insulation-stripping installation can operate as follows. The flat material to be stripped of the insulation is initially infed by the drawing-in installation until the beginning of a portion to be stripped of the insulation makes its way into the plane which is defined by the rotation axes 232, 242 of the knife shafts. The knives in this phase are situated in the passing position (cf. FIG. 4). The drawing-in is then stopped. The first knives 235-1, 245-1 by rotating the knife shafts are brought contemporaneously into operative engagement and hereby plunge through the insulation layer down to the level of the faces of the carrier material to be exposed (cf. FIG. 5A). The flat material by way of the drawing-in installation is then conveyed onward. The actual insulation-stripping procedure takes place herein (cf. FIG. 6). After a pre-definable length of the infeed, once the end of the portion to be stripped of the insulation has been reached, the drawing-in is stopped. Thereafter, the knife shafts are rotated by 180° counter to the plunging direction, and the second knives on account thereof come to engage with the insulation material and sever the shavings (cf. FIG. 7). The shavings drop into a collection container. For the flat material to be released prior to onward conveying, the knife shafts are rotated to a neutral position, for example, by 90°.

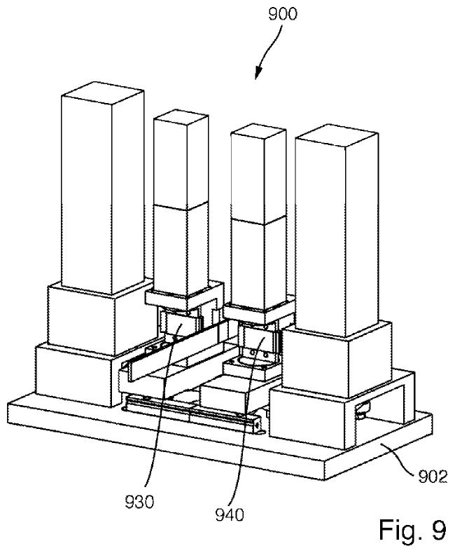

Another example of an insulation-stripping installation 900 will be explained by FIG. 9. The insulation-stripping installation 900 is not provided for assembly on the drawing-in installation, but for installation in the installation space between the drawing-in installation and the following cutting installation. The insulation-stripping installation has a frame 902, the plate-shaped lower part thereof being fastened to the machine bed of the machine. The lower part supports all functional components of the insulation-stripping installation. A catch tray for severed shavings from insulation material can inter alia be provided on the lower side of the lower part. In a manner similar to the example of FIGS. 1 to 7, the insulation-stripping installation has two knife shafts 930 and 940 rotatable in an axially parallel manner and each have one pair of knives (first and second knives) having straight cutting edges. The rotating movements of the knife shafts for changing between the individual positions (operating position for insulation-stripping, position for severing shavings, neutral position) are each generated by a dedicated servomotor having a gearbox. Synchronization of the movements is performed to be controlled by software.

Each of the knife shafts is mounted in a dedicated U-shaped profile assembled on a linear unit. The spacing between the rotation axes of the knife shafts (or the available operative spacing between the cutting edges of the knives in the operating position thereof, respectively) can be adjusted in a stepless manner with the aid of the linear units. For each knife shaft there is a knife that by way of the tongue-and-groove connection is placed and assembled to be centric on the shaft. Setting the approach and the post adjustment are performed by way of a crank drive. The shavings are collected by way of an integrated drawer (catch tray) in the frame.

In this example, the flat material to be stripped of the insulation is first stopped at the provided insulation-stripping location and then positioned at an angle. The knife shafts are then set to approach. The knife shafts subsequently plunge, that is to say that the knife shafts are rotated to the operating position thereof. This can be implemented automatically or manually. The flat material for the actual insulation-stripping procedure (the insulation-stripping operation) is then conveyed onward by the drawing-in installation. The drawing-in is stopped after the predefined length. The knife shafts then rotate by 180° counter to the plunging direction, on account of which the shaving from insulation material is severed and drops into the catch tray. The knife shafts thereafter are rotated back to the neutral position thereof, for example, by 90°. The approach setting is then reversed.

In this way, the two opposite broadsides of the flat material are stripped of the insulation, for example. When the narrow sides are also to be stripped of the insulation, the flat material with the aid of the drawing-in installation can be conveyed back such that the beginning of the portion to be stripped of the insulation lies in the region of the knife shafts again. The drawing-in is rotated by 90° for the insulation-stripping of the narrow edges. The steps of stripping the insulation from the narrow sides described above are then repeated. The flat material thereafter is released by reversing the knives and can be conveyed onward.

By virtue of the possibility of the variation of the spacing between the rotation axes of the knife shafts, this example of an insulation-stripping installation is particularly flexible and can also be more comfortable, in particular when the spacing is set automatically by a servomotor. This example is suitable for all sizes of flat material without retooling. Potential wear on the knives can be automatically compensated for by the possibility of the variation of the spacing between the rotation axes of the knife shafts. The closed catch tray is intended to ensure a comfortable, remnant-free disposal of the insulation material shavings.

1-18. (canceled)

19. A method of producing a bent part from insulated flat material having a flat electrically conducting carrier material sheathed by an electrically insulating insulation layer. comprising:
feeding the insulated flat material from a material supply to a bending machine;
in the bending machine, forming a two-dimensionally or three-dimensionally bent part bent from insulated flat material;
severing the bent part in a cutting operation from the fed insulated flat material; and
removing part of the insulation layer in an insulation-stripping operation from the electrically conducting carrier material in at least one portion of the insulated flat material, wherein
the insulation-stripping operation on the flat material guided in the bending machine by an insulation-stripping installation that is integrated in the bending machine is carried out by a continuous method on the flat material running through the insulation-stripping installation prior to severing the bent part from the fed flat material.

20. The method as claimed in claim 19, wherein an infeed movement of the flat material in the running direction in the continuous method is predefined by actuating a drawing-in installation and/or by operative movements of a bending installation of the bending machine, and, optionally, the insulation-stripping operation is carried out by way of an insultation-stripping installation that is disposed to be static.

21. The method as claimed in claim 19, wherein the insulation-stripping operation by the insulation-stripping installation is carried out under control of a control installation of the bending machine.

22. The method as claimed in claim 19, wherein the flat material to be stripped of the insulation during the insulation-stripping operation on both sides of a portion to be stripped of the insulation is guided through and/or held by controllable installations of the bending machine or through a drawing-in installation and a bending installation.

23. The method as claimed in claim 19, wherein the insulation layer by a knife having a straight cutting edge is removed on at least one lateral face of the flat material, said straight cutting edge in an operating position of the knife being disposed close to a lateral face of the carrier material to be exposed such that a part of the insulation layer acquired by the knife is removed from the carrier material in the continuing movement of the flat material relative to the knife.

24. The method as claimed in claim 23, wherein the knife moved to the operating position rests during the insulation-stripping operation, and relative movement between the knife and the flat material required for removal of the insulation layer is caused exclusively by movement of the flat material in a running direction.

25. The method as claimed claim 19, wherein the flat material is contemporaneously stripped of the insulation on at least two opposite sides of the flat material.

26. A system that produces bent parts from insulated flat material, having a bending machine that bends insulated flat material and an insulation-stripping installation that strips the insulation from portions of the insulated flat material,
wherein the bending machine has a drawing-in installation that draws-in insulated flat material from a material supply, a bending installation having a bending head that bends the insulated flat material to a two-dimensional or three-dimensional bent part bent from insulated material and a cutting installation that severs the bent part from the fed insulated flat material, and
the bending machine has an integrated insulation-stripping installation that strips the insulation of portions of the insulated flat material by a continuous method on the flat material running through the insulation-stripping installation prior to the severing of the bent part from the fed flat material.

27. The system as claimed in claim 26, wherein the insulation-stripping installation connects to a control installation of the bending machine, and the insulation-stripping operation is capable of being carried out by the insulation-stripping installation under control of the control installation.

28. The system as claimed in claim wherein the insulation-stripping installation is disposed to be static and/or between the drawing-in installation and a bending head of the bending installation.

29. The system as claimed in claim 26, wherein the drawing-in installation is rotatable about a drawing-in axis, and the insulation-stripping installation is fastened to the drawing-in installation and, conjointly with the drawing-in installation, is rotatable about the drawing-in direction.

30. The system as claimed in claim 26, wherein the insulation-stripping installation has at least one knife having a straight cutting edge, and the knife is movable between a neutral position without an engagement of the knife on the insulated flat material and an operating position in which the cutting edge of the knife is disposed close to a lateral face of the carrier material to be exposed such that a part of the insulation layer acquired by the knife is removed from the carrier material in the continuing movement of the flat material relative to the knife.

31. The system as claimed in claim 26, wherein the insulation-stripping installation has at least one knife shaft rotatable about a rotation axis and supports a knife having a straight cutting edge, the knife by the rotation of the knife shaft about the rotation axis is movable from a neutral position to an operating position and, optionally, in an opposing direction, from the operating position to the neutral position.

32. The system as claimed in claim 31, further comprising a further knife attached to the knife shaft, said further knife by the rotation of the knife shaft being movable to operatively engage with the flat material in the manner that a portion of the insulation material peeled off by the knife is capable of being severed from the insulation material remaining on the carrier material by the further knife.

33. The system as claimed in claim 30, wherein the knife has a cutting wedge having a cutting face and a tool flank, and the knife is designed and disposed such that the tool flank in the operating position runs to be substantially parallel to the lateral face of the carrier material to be exposed.

34. The system as claimed in claim 31, wherein the knife shaft in relation to the flat material running through is disposed such that a radial plane defined by the cutting edge of the knife and the rotation axis of the knife shaft lies is substantially perpendicular on the lateral face of the carrier material to be exposed when the knife is situated in the operating position.

35. The system as claimed in claim 31, wherein the insulation-stripping installation has a first knife shaft and a second knife shaft rotatable about mutually parallel rotation axes, and a passage opening for the flat material to be stripped of the insulation lies between the knife shafts.

36. The system as claimed in claim 35, wherein a spacing between the rotation axes of the knife shafts is adjustable in a stepless manner.
